(19) United States
(12) Patent Application Publication
(10) Pub. No.: US 2007/0042087 A1
(43) Pub. Date: Feb. 22, 2007

(54) Apparatus for making selectively designed breakfast cakes

(76) Inventor: Jason Reese, Provo, UT (US)

Correspondence Address: KUNZLER & ASSOCIATES, 8 EAST BROADWAY, SUITE 600, SALT LAKE CITY, UT, 84111, US

(21) Appl. No.: 11/206,456

(22) Filed: Aug. 18, 2005

(51) Int. Cl. A23G 1/00

(52) U.S. Cl. 426/104

(57) ABSTRACT

An apparatus is disclosed for making selectively designed breakfast cakes. In one embodiment, the present invention includes a top and bottom cover each having a heat source and able to receive a top and bottom design plate respectively. The top and bottom design plate impose a design such as a star or tree on the breakfast cake. The top and bottom design plate may be substantially similar. In certain embodiments, the top and bottom cover each include a bracket system for receiving a design plate. In other embodiments, the present invention also includes an interface panel, a base, a mechanically retractable power cord, and a handle.

### BACKGROUND OF THE INVENTION

1. Field of the Invention

This invention relates to breakfast cake cookers and more particularly relates to breakfast cake cookers capable of making selectively designed breakfast cakes.

2. Description of the Related Art

Breakfast cakes are a central part of many meals. Breakfast cakes include a variety of batter based foods including waffles and pancakes. Additionally, breakfast cakes may be cooked using a variety of instruments such as pans, waffle irons, or griddles. Such instruments are often referred to collectively as breakfast cake cookers. Despite the number of breakfast cake cookers, the ability to selectively design or shape breakfast cakes is minimal at best.

For example, a griddle includes a substantially planar and often rectangular heating device. As pancake batter is introduced to the substantially planar device, the batter naturally forms a circular design. Though the griddle is effective in cooking the pancake batter, the griddle does not provide a method for physically controlling the design of the pancake. Accordingly, all pancakes cooked thereon form the same circular design.

Similarly, a waffle iron includes an upper hot plate and a lower hot plate. The hot plates are often hinged to facilitate their meeting. As waffle batter is introduced to the lower hot plate, the batter conforms to the predetermined, static design of the hot plate. Though the waffle iron is effective in cooking the waffle, it does not provide a method for selecting an alternate design for the waffle.

Additionally, other breakfast cake cookers fail to provide other features that facilitate cooking breakfast cakes. For example, certain breakfast cake cookers fail to provide a temperature gauge, heat sensor, and lighting system to notify the readiness of the breakfast cake. Other breakfast cake cookers fail to provide a handle or a mechanically retractable cord that facilitate transporting and storing the breakfast cake cooker.

From the foregoing discussion, it should be apparent that a need exists for a breakfast cake cooker capable of making selectively designed breakfast cakes. Beneficially, such a breakfast cake cooker would provide the ability to create breakfast cakes in various designs in addition to providing other beneficial features such as a temperature gauge, handle, lighting system, mechanically retractable cord, and so on.

### SUMMARY OF THE INVENTION

The present invention has been developed in response to the present state of the art, and in particular, in response to the problems and needs in the art that have not yet been fully solved by currently available breakfast cake cookers. Accordingly, the present invention has been developed to provide a breakfast cake cooker that overcomes many or all of the above-discussed shortcomings in the art.

The present invention is provided with a plurality of elements configured to functionally execute the necessary steps to make selectively designed breakfast cakes. These elements in the described embodiments include a top and bottom cover each having an integrated heat source and capable of receiving a top and bottom design plate respectively. Additionally, the top and bottom cover may each include a bracket system for receiving a design plate. The top and bottom design plates each impose a design on the breakfast cake. The top and bottom design plates may be substantially similar and include designs such as a heart, lips, rose, four leaf clover, rainbow, and so on.

In certain embodiments, the breakfast cake cooker includes an interface panel for communicating status information such as time, temperature, and power. In some embodiments, the top and bottom cover each include a handle that facilitates operating and transporting the breakfast cake cooker. Also in some embodiments, the breakfast cake cooker includes a mechanically retractable power cord and heat-resistant base. Accordingly, the disclosed breakfast cake cooker provides means for making selectively designed breakfast cakes.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of one embodiment of a breakfast cake cooker in accordance with the present invention;

FIG. 2 is a perspective view of one embodiment of a breakfast cake cooker in accordance with the present invention;

FIG. 3a is a perspective view of one embodiment of a breakfast cake cooker in accordance with the present invention;

FIG. 3b is an exploded, cross section view of one embodiment of a latch in accordance with the present invention;

FIG. 3c is an exploded, cross section view of one embodiment of a latch and a design plate in accordance with the present invention;

FIG. 3d is an exploded, cross section view of one embodiment of a latch and a design plate in accordance with the present invention;

FIG. 4 is a perspective view of one embodiment of a top design plate and a bottom design plate in accordance with the present invention;

FIG. 5 is a side view of one embodiment of a breakfast cake cooker in accordance with the present invention;

FIG. 6 is a top view of one embodiment of a breakfast cake cooker in accordance with the present invention; and

FIG. 7 is a bottom view of one embodiment of a breakfast cake cooker in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of hardware, physical pieces of the apparatus, etc., to provide a thorough understanding of embodiments of the invention. One skilled in the relevant art will recognize, however, that the invention may be practiced without one or more of the specific details, or with other components, materials, and so forth. In other instances, well-known structures or materials are not shown or described in detail to avoid obscuring aspects of the invention.

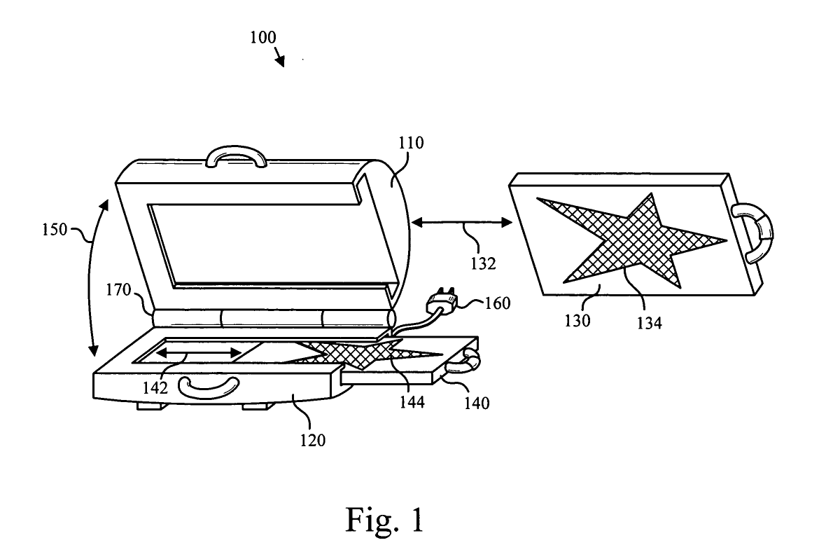

FIG. 1 is a perspective view of a breakfast cake cooker 100 in accordance with the present invention. The breakfast cake cooker 100 includes a top cover 110, a bottom cover 120, a top design plate 130, a bottom design plate 140, a power cord 160, and a hinge 170. The various components of the breakfast cake cooker 100 function cooperatively to make selectively designed breakfast cakes.

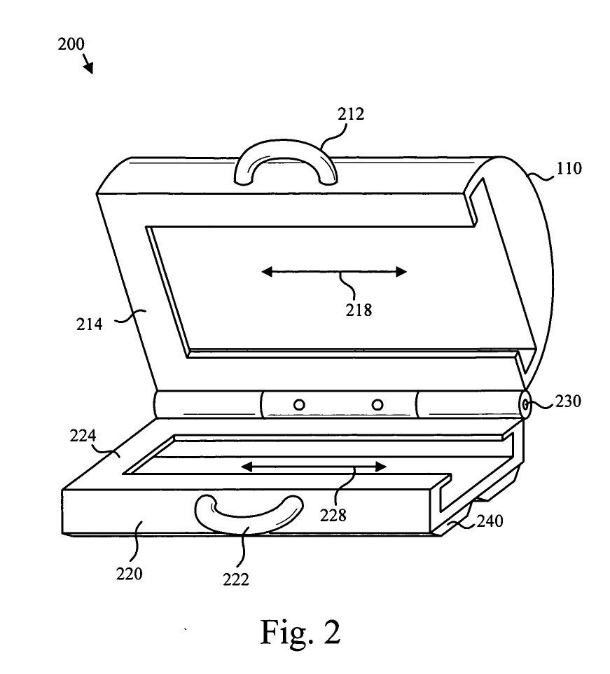

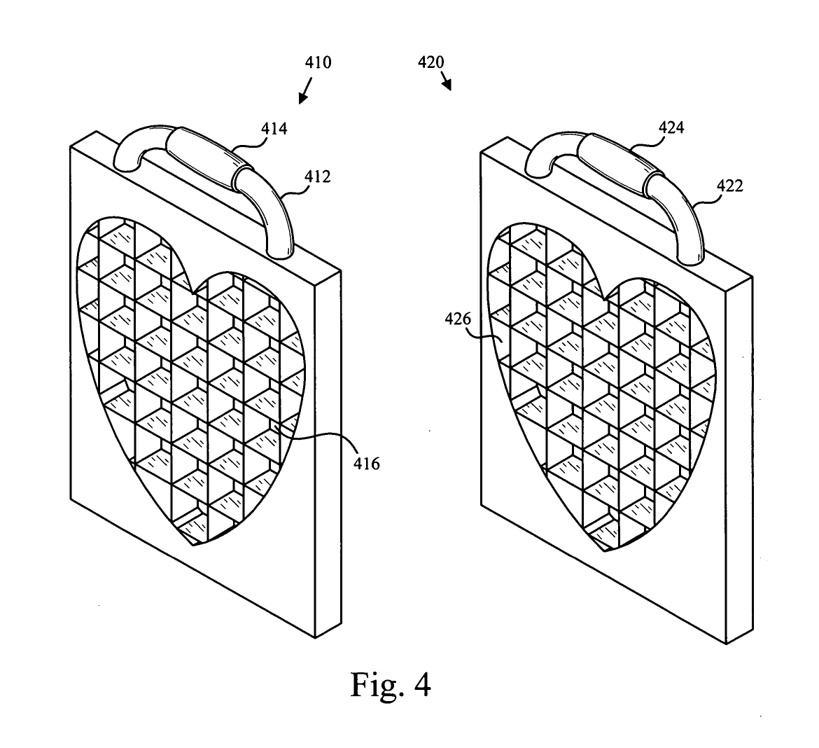

The top and bottom covers 110, 120 receive a top and bottom design plate 130, 140 in the directions 132 and 142, respectively. The top and bottom covers 110, 120 will be further detailed in FIG. 2. The design plates 130, 140 may include any variety of designs 134, 144 such as a star, tree, cake, balloon, and so on. In certain embodiments the design plates 130, 140 include designs 134, 144 having a waffle-like texture. In other embodiments, the design plates 130, 140 include designs 134, 144 having a pancake-like texture. The top and bottom design plates 130, 140 will be further detailed in FIG. 4. Once the top and bottom cover 130, 140 each receive a design plate 130, 140, breakfast cake batter may be added to the design 144 of the bottom design plate 140. Accordingly, the liquid batter conforms to the design 144 of the bottom design plate 140.

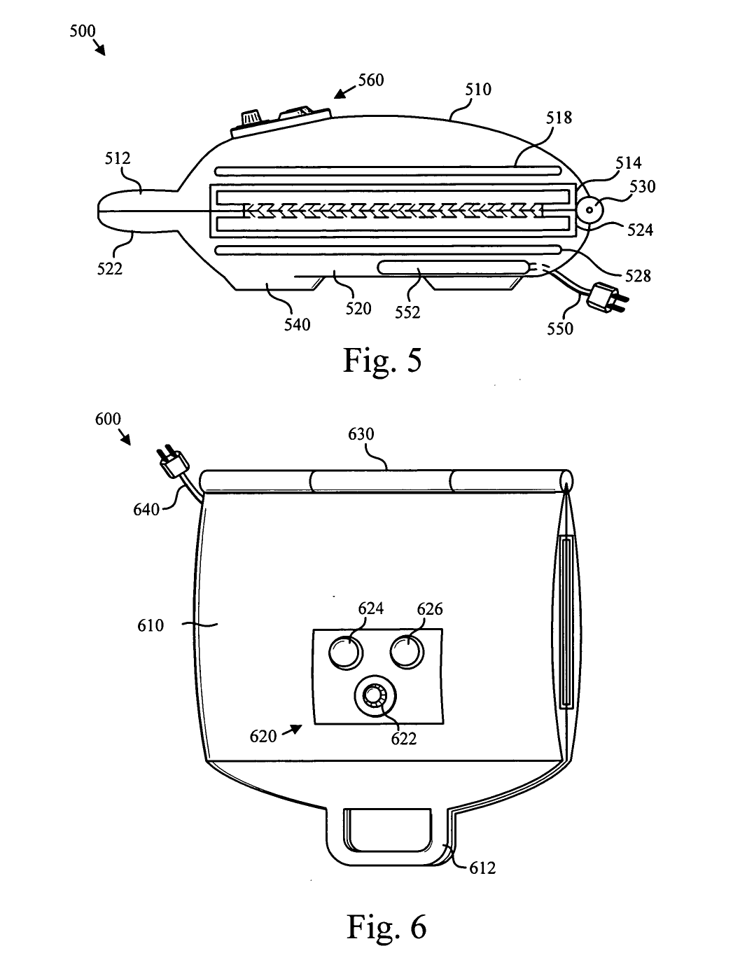

The breakfast cake cooker 100 may then be closed by rotating the top plate 110 about the hinge 170 in the direction 150, until the perimeter of the top and bottom covers 110, 120 meet (see FIG. 5). As the top design plate 130 comes in contact with the batter resting in the bottom design plate 140, the batter conforms to the design 134 of the incoming top design plate 130. The power cord 160 may be inserted into an electrical outlet or other power source to power to the breakfast cake cooker 100. When powered, the breakfast cake cooker 100 heats and cooks the batter in conformity with the designs 134, 144. Accordingly, the breakfast cake cooker 100 makes selectively designed breakfast cakes.

FIG. 2 is a perspective view of a breakfast cake cooker 200 in accordance with the present invention. The breakfast cake cooker 200 includes a top cover 210, a top handle 212, a top bracket system 214, a bottom cover 220, a bottom handle 222, a bottom bracket system 224, a hinge 230, and a base 240. The depicted breakfast cake cooker 200 is a resource for making selectively designed breakfast cakes.

As depicted, the top cover 210 may be substantially rectangular. In another embodiment, the top cover 210 may instead be substantially circular, octagonal, or square. Additionally, the top, outside portion of the top cover 210 may include various contours including planar or arched contours (as depicted). Additionally, the top cover 210 may include a variety of materials such as aluminum, steel, copper, porcelain, cast iron, or hard plastic. In certain embodiments, the top cover 210 includes a heat resistant material that enables the top cover 210 to remain relatively cool while the breakfast cake cooker 200 is operating.

The top cover 210 may also include a top handle 212. As depicted, the top handle 212 may protrude from the top cover 210 on the opposite side of the hinge 230. In other embodiments, the top handle 212 may be positioned elsewhere. Similar to the top cover 210, the top handle 212 may include any functional material such as aluminum, steel, porcelain, copper, cast iron, rubber, or hard plastic. In one embodiment, the top handle 212 is constructed of the same material as the top cover 210. Indeed, the top cover 210 and top handle 212 may be integrally formed

In certain embodiments, the handle 212 includes a heat resistant material, thereby allowing operation of the breakfast cake cooker 200 while the breakfast cake cooker 200 is hot. Additionally, the top handle 212 may take on various shapes including a shape congenial to the contour of a human hand. For example, the depicted handle 212 includes a semi-circular shape. The shape and make of the top handle 212 may facilitate top cover 210 mobility.

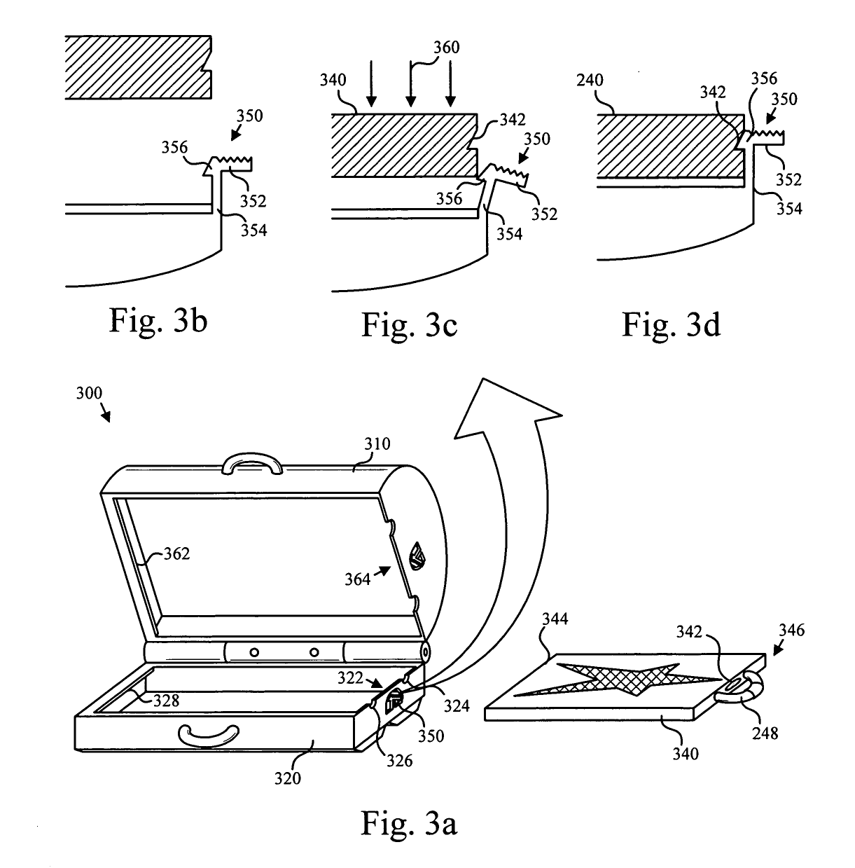

The depicted top bracket system 214 is affixed to the top cover 210 and receives a top design plate in the direction 218. In other embodiments, the top bracket system 214 may be substituted by alternative designs for design plate reception, as will be further detailed in FIG. 3. In the depicted embodiment, the top bracket system 214 includes three enclosed, shelved sides and one open side for inserting a top design plate (see also FIG. 1). The bracket system 214 may include a material capable of withstanding high temperatures such as cast iron, aluminum, copper, tin, or steel. In certain embodiments, the material is coated with Teflon, or the like, to facilitate cleaning excess batter from the top bracket system 214.

Similar to the top cover 210, the bottom cover 220 may be substantially rectangular, as depicted. The bottom, outside portion of the bottom cover 220 may include various contours including slightly arched or planar. In certain embodiments, the bottom cover 220 is complimentary to the top cover 210. Additionally, the bottom cover 220 may include a variety of materials such as aluminum, steel, copper, cast iron, porcelain, or hard plastic. Also similar to the top cover 210, the bottom cover 220 may include a heat resistant material that enables the bottom cover 220 to remain relatively cool while the breakfast cake cooker 200 is operating.

In certain embodiments, the bottom cover 220 may have a bottom handle 222. As depicted, the bottom handle 222 may protrude from the bottom cover 220 on the opposite side of the hinge 230. In other embodiments, the bottom handle 222 may be positioned elsewhere. Similar to the bottom cover 220, the bottom handle 222, may include any functional material such as aluminum, steal, copper, cast iron, rubber, porcelain, or hard plastic. In one embodiment, the bottom handle 222 is constructed of the same material as the bottom cover 220. Indeed, the bottom cover 220 and bottom handle 222 may be integrally formed. In certain embodiments, the bottom handle 222 includes a heat resistant material, thereby providing safety when operating the breakfast cake cooker 200 while the breakfast cake cooker 200 is hot.

Additionally, the bottom handle 222 may take on various shapes including a shape congenial to the contour of a human hand. For example, the depicted bottom handle 222 includes a semi-circular shape. The shape and make of the bottom handle 222 may facilitate bottom cover 220 mobility. As depicted, the top handle 212 and bottom handle 222 may be congruent as to both shape and positioning such that when the top cover 210 and bottom cover 220 meet, the handles 212, 222 essentially create a single handle to facilitate transporting or storing the breakfast cake cooker 200.

Similar to the top bracket system 214, the depicted bottom bracket system 224 is affixed to the bottom cover 220 and provides a means for receiving and removing a bottom design plate 140 in the direction 228. In other embodiments, the bottom bracket system 224 may be substituted by alternative designs for design plate reception as will be further detailed in FIG. 3. In the depicted embodiment, the bottom bracket system 224 includes three enclosed, shelved sides and one open side. The three enclosed, shelved sides may include a material capable of withstanding cooking temperatures such as cast iron, aluminum, copper, tin, or steel. In certain embodiments, the material may be coated with Teflon, or the like, to facilitate cleaning excess batter from the bottom bracket system 224.

FIG. 3a is a perspective view of a breakfast cake cooker 300 and bottom design plate 340 in accordance with the present invention. The breakfast cake cooker 300 includes a top cover 310, a bottom cover 320, and a bottom design plate 340. The depicted breakfast cake cooker 300 illustrates an alternative embodiment for receiving a design plate.

The bottom cover 320 includes a receiving bracket 328 for receiving the design plate end 344. Once the receiving bracket 328 receives the design plate end 344, the design plate 340 may be rotated downward to engage the handle receiver 322 with the handle end 346 of the design plate 340. The handle receiver 322 includes a first handle divot 324, a second handle divot 326, and a latch 350.

FIG. 3b is an exploded, cross sectional view of the latch 350. The latch 350 includes a latch handle 352, plate hook 356, and resilient base 354. As depicted in FIG. 3c, the bottom design plate 340 is inserted in the direction 360. The resilient base 354 enables the latch 350 to rotate away from the incoming design plate 340. As seen in FIG. 3d, inserting the bottom design plate 340 enables the resilient base 354 to engage the hook 356 with lever receiver 342, thereby securing the design plate 340 to the bottom cover 320.

Removing the design plate 340 includes applying pressure to the latch handle 352 such that the hook 356 is removed from the latch receiver 342. Once the hook 356 fully disengages from the latch receiver 342, the design plate 340 may be removed opposite the direction 360, whereupon the resilient base 354 returns to its original position. Inserting and removing a design plate in this manner is replicable with the top cover 310 as the top cover 310 also includes a receiving bracket 362 and handle receiver 360.

FIG. 4 depicts a perspective view of a top design plate 410 and a bottom design plate 420. Each plate 410, 420 include a handle 412, 422, a handle cover 414, 424, a design body 416, 426. The design plate bodies 416, 426 substantially dictate the physical shape of the breakfast cake. As depicted, the top and bottom design plates 410, 420 may be substantially similar.

The top and bottom design plates 410, 420 may include a material capable of conducting heat for cooking breakfast cakes such as cast iron, copper, tin, steel, or aluminum. In certain embodiments, the plates 410, 420 are coated with a non-stick substance such as Teflon, or the like, to ensure that cooked batter is easily removable therefrom. The size of the top and bottom design plates 410, 420 are such that the plates 410, 420 may be received by the top and bottom covers 110, 120 respectively (see FIG. 1).

The top and bottom handles 412, 422 may facilitate insertion and removal of the plates 410, 420 from the top and bottom covers 110, 120 (see FIG. 1). In another embodiment, the top and bottom handles 412, 422 may act as the top and bottom cover handles 212, 222 to facilitate opening and closing of the breakfast cake cooker 200 (see FIG. 2). The top and bottom handles 412, 422 may include handle covers 414, 424 to accommodate insertion and removal of the design plates 410, 420 from the top and bottom covers 110, 120 (see FIG. 1). In one embodiment, the handle covers 414, 424 include a heavy rubber.

The depicted top and bottom design bodies 416, 426 of design plates 410, 420 have waffle-like textures. In another embodiment, the top and bottom design bodies 416, 426 have smooth textures. The top and bottom design bodies 416, 426 may be substantially similar. The depicted top and bottom design bodies 416, 426 resemble a heart. In other embodiments, the top and bottom design bodies 416, 426 resemble lips, a rose, a four leaf clover, a rainbow, a pot of gold, a bunny, an egg, a duck, a bat, a ghost, a pumpkin, a jack-o-lantern, a turkey, a feather, a pilgrim hat, a star, a tree, an angel, a Santa Clause, a reindeer, a present, a sun, a leaf, a snowman, a flower, a beach ball, a pail and shovel, a pumpkin, a scarecrow, a snowflake, a mitten, a cloud, a tree, a cake, a birthday hat, a present, a basketball, a football, a baseball, a surfboard, a smiley face, a butterfly, a guitar, an alphabet, and a number.

FIG. 5 depicts a side view of a breakfast cake cooker 500 in accordance with the present invention. The breakfast cake cooker 500 includes a top and bottom cover 510, 520, a top and bottom handle 512, 522, a top and bottom bracket system 514, 524, a top and bottom heating element 518, 528, a hinge 530, a base 540, a power cord 550, a power cord retraction mechanism 552, and an interface panel 560. The depicted breakfast cake cooker 500 makes selectively designed breakfast cakes.

The breakfast cake cooker 500 is depicted in a closed position as the top and bottom plates 510, 520 have met. In the depicted embodiment, the breakfast cake cooker 500 in a closed position consequentially meets the top and bottom handle 512, 522. Accordingly, the top and bottom handle 512, 522 may be used to separate the top and bottom plates 510, 520 in preparation for inserting a design plate or adding batter to the breakfast cake cooker 500. Additionally, when the top and bottom handles 512, 522 meet, a single handle may be formed to facilitate positioning or transporting the breakfast cake cooker 500.

The hinge 530 provides mechanical means for opening and closing the top cover 510 and the bottom cover 520. In certain embodiments, the breakfast cake cooker 500 does not include a hinge or any other mechanical means for closing the top cover 510. In such an embodiment, closing the breakfast cake cooker 500 may include placing the top cover over the bottom cover 520.

The power cord 550 may engage an outlet and thereby provide power to the breakfast cake cooker 500. Once powered, the heating elements 518, 528 may begin producing heat necessary to cook breakfast cake batter. In certain embodiments, the breakfast cake cooker 500 also includes a power button or power switch for toggling the breakfast cake cooker 500 on and off.

When power is no longer needed, the power cord 550 may be removed from the outlet and collected via the power cord retraction mechanism 552. The retraction mechanism 552 may include a spring loaded, electrically powered, or manually cranked retraction mechanism for retracting and storing the power cord 550. Accordingly, the retraction mechanism 552 facilitates storage and transportation of the breakfast cake cooker 500.

FIG. 6 is a perspective top view of a breakfast cake cooker in accordance with the present invention. The breakfast cake cooker 600 includes a top cover 610, a top handle 612, an interface panel 620, a hinge 630, and a power cord 640. The depicted breakfast cake cooker 600 makes selectively designed breakfast cakes.

The interface panel 620 communicates status information to a user. The depicted interface panel 620 is positioned on the top cover 610, but could be positioned in other locations as well. The depicted interface panel 620 includes a thermostat 622, a first indicator light 624, a second indicator light 626, and a heat sensor (not shown). The instruments included in the interface panel 620 need not be positioned proximate one another, but may be distributed throughout the breakfast cake cooker 600. Additionally, the interface panel 620 may include any combination of interface instruments such as an indicator light, mechanical temperature dial, thermometer, heat sensor, digital interface screen, beeper, and so on.

In the depicted embodiment, the thermostat 622 sets the cooking temperature of the breakfast cake cooker 600 and the heat sensor (not shown) determines the temperature of the breakfast cake. As the breakfast cake becomes warm, the first indicator light 624 indicates a cooking mode. Once the breakfast cake reaches a certain temperature, the second indicator light 626 indicates that the breakfast cake is done and should be removed from the breakfast cake cooker 600.

Other embodiments may include a digital thermostat or thermometer to indicate the target cooking temperature or actual cooking temperature. Additionally, the interface panel 620 may include a beeper or other device for creating sound waves to communicate breakfast cake readiness or temperature status. In other embodiments, the interface panel 620 may include a digital or mechanical timer in combination with an indicator light or beeper for setting and tracking the breakfast cake cooking time. Accordingly, the interface panel 620 may include a variety of components for facilitating breakfast cake cooking.

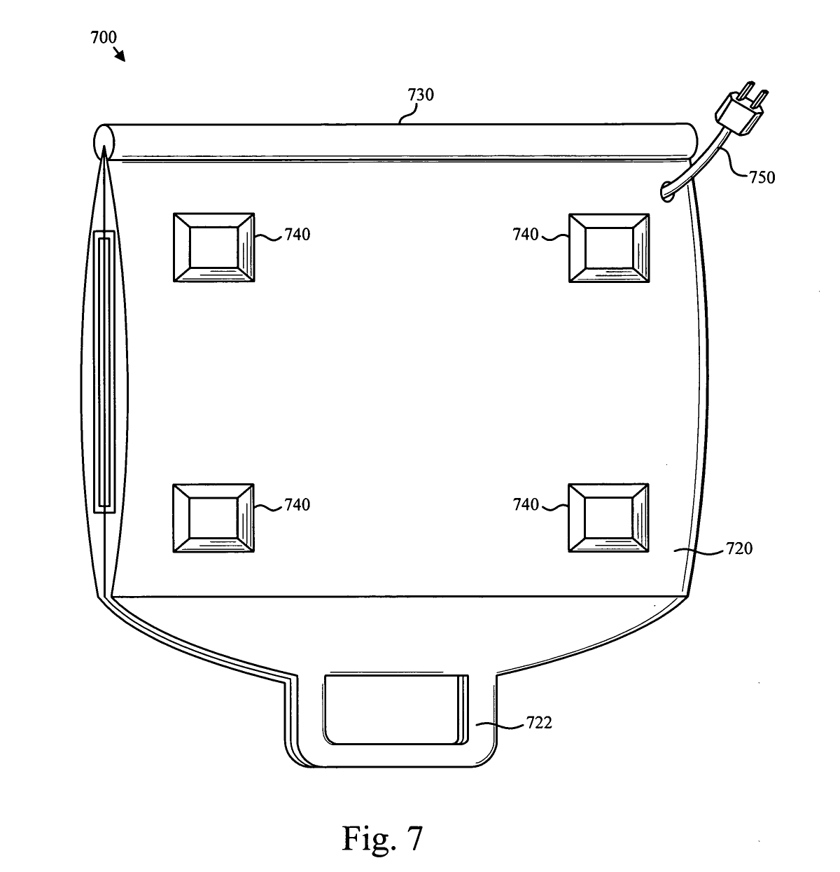

FIG. 7 is a perspective bottom view of a breakfast cake cooker 700 in accordance with the present invention. The depicted breakfast cake cooker 700 includes a bottom cover 720, a bottom handle 722, a hinge 730, a base 740, and a power cord 750. The depicted breakfast cake cooker 700 illustrates one embodiment of a base 740.

The depicted base 740 provides stability to the breakfast cake cooker 700 and includes four footings attached to the bottom cover 720. However, the base 740 may be embodied by structures other than four footings, such as a single, heat-resistant compound covering the bottom cover 720. The base 740 may include any stabilizing or heat-resistant material such as metal, rubber, hard plastic, porcelain, etc. In certain embodiments, the base 740 may include a water or slip-resistant material such as rubber, to deter the breakfast cake cooker 700 from sliding.

In other embodiments, the base 740 and bottom cover 720 may be of the same material such that the base 740 and bottom cover 720 substantially comprise one unitary body. Additionally, the base 740 may be embodied as different shapes, styles, or structures. For example, the base 740 may take on the shape of a circle or plurality of circles dispersed about the bottom cover 720. In other embodiments, the base 740 may include a riveted or waved rubber, lining the bottom cover 720.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for making selectively designed breakfast cakes, the apparatus comprising:
a top cover having a top heat source integrated therein, the top cover configured to receive a top design plate;
the top design plate configured to impose a first design on a breakfast cake;
a bottom cover having a bottom heat source integrated therein, the bottom cover configured to receive a bottom design plate; and
the bottom design plate configured to impose a second design on the breakfast cake.

2. The apparatus of claim 1, wherein the top cover or the bottom cover comprises a bracket system configured to receive a design plate.

3. The apparatus of claim 1, further comprising an interface panel configured to communicate status information.

4. The apparatus of claim 1, further comprising a handle.

5. The apparatus of claim 1, further comprising a top handle integrated into the top cover and a bottom handle integrated into the bottom cover, the top and bottom handles configured to mate, and form a single handle.

6. The apparatus of claim 1, further comprising a power cord.

7. The apparatus of claim 6, wherein the power cord is mechanically retractable.

8. The apparatus of claim 1, further comprising a base.

9. The apparatus of claim 1, wherein the top design plate and bottom design plate have a similar design.

10. The apparatus of claim 1, wherein the top design plate and bottom design plate each comprise a handle for removing the top and bottom design plate from the top and bottom cover respectively.

11. The apparatus of claim 1, wherein the first design imposed by the top design plate and the second design imposed by the bottom design plate are selected from the group consisting of a heart, lips, a rose, a four leaf clover, a rainbow, a pot of gold, a bunny, an egg, a duck, a bat, a ghost, a pumpkin, a jack-o-lantern, a turkey, a feather, a pilgrim hat, a star, a tree, an angel, a Santa Clause, a reindeer, a present, a sun, a leaf, a snowman, a flower, a beach ball, a pail and shovel, a pumpkin, a scarecrow, a snowflake, a mitten, a cloud, a tree, a cake, a birthday hat, a present, a basketball, a football, a baseball, a surfboard, a smiley face, a butterfly, a guitar, an alphabet, and a number.

12. An apparatus for making selectively designed breakfast cakes, the apparatus comprising:
a top cover having a top heat source integrated therein, the top cover configured to receive a top design plate;
the top design plate configured to impose a first design on a breakfast cake;
a bottom cover having a bottom heat source integrated therein, the bottom cover configured to receive a bottom design plate;
the bottom design plate configured to impose a second design on the breakfast cake;
a power cord; and
a base configured to stabilize and elevate the bottom cover.

13. The apparatus of claim 12, wherein the top cover or the bottom cover comprises a bracket system configured to receive a design plate.

14. The apparatus of claim 12, further comprising an interface panel configured to communicate status information.

15. The apparatus of claim 12, further comprising a handle.

16. The apparatus of claim 12, further comprising a top handle integrated into the top cover and a bottom handle integrated into the bottom cover, wherein the top and bottom handles are configured to mate, thereby forming a single handle.

17. The apparatus of claim 12, wherein the power cord is mechanically retractable.

18. The apparatus of claim 12, wherein the top design plate and bottom design plate have a similar design.

19. The apparatus of claim 12, wherein the top design plate and bottom design plate each comprise a handle for removing the top and bottom design plate from the top and bottom cover respectively.

20. The apparatus of claim 12, wherein the first design imposed by the top design plate and the second design imposed by the bottom design plate are selected from the group consisting of a heart, lips, a rose, a four leaf clover, a rainbow, a pot of gold, a bunny, an egg, a duck, a bat, a ghost, a pumpkin, a jack-o-lantern, a turkey, a feather, a pilgrim hat, a star, a tree, an angel, a Santa Clause, a reindeer, a present, a sun, a leaf, a snowman, a flower, a beach ball, a pail and shovel, a pumpkin, a scarecrow, a snowflake, a mitten, a cloud, a tree, a cake, a birthday hat, a present, a basketball, a football, a baseball, a surfboard, a smiley face, a butterfly, a guitar, an alphabet, and a number.

21. An apparatus for making selectively designed breakfast cakes, the apparatus comprising:
a top cover having a top heat source integrated therein, the top cover configured to receive a top design plate;
the top design plate configured to impose a first design on a breakfast cake;
a bottom cover having a bottom heat source, integrated therein, the bottom cover configured to receive a bottom design plate;
the bottom design plate configured to impose a second design on the breakfast cake;
a power cord;
a base configured to stabilize and elevate the bottom cover;
an interface panel configured to communicate status information; and
the top design plate and bottom design plate each comprising a handle configured to facilitate separation of the top design plate and bottom design plate from the top cover and bottom cover respectively.

22. The apparatus of claim 21, wherein the top cover or the bottom cover comprises a bracket system configured to receive a design plate.

23. The apparatus of claim 21, wherein the power cord is mechanically retractable.

24. The apparatus of claim 21, further comprising a top handle integrated into the top cover and a bottom handle integrated into the bottom cover, wherein the top and bottom handles are configured to mate, thereby forming a single handle.

25. The apparatus of claim 21, wherein the top design plate and bottom design plate have a similar design.

26. The apparatus of claim 21, wherein the first design imposed by the top design plate and the second design imposed by the bottom design plate are selected from the group consisting of a heart, lips, a rose, a four leaf clover, a rainbow, a pot of gold, a bunny, an egg, a duck, a bat, a ghost, a pumpkin, a jack-o-lantern, a turkey, a feather, a pilgrim hat, a star, a tree, an angel, a Santa Clause, a reindeer, a present, a sun, a leaf, a snowman, a flower, a beach ball, a pail and shovel, a pumpkin, a scarecrow, a snowflake, a mitten, a cloud, a tree, a cake, a birthday hat, a present, a basketball, a football, a baseball, a surfboard, a smiley face, a butterfly, a guitar, an alphabet character, and a number.
